(19) United States
(12) Patent Application Publication
(10) Pub. No.: US 2025/0141032 A1
(43) Pub. Date: May 1, 2025

(54) BATTERY CELL AND ELECTRICAL DEVICE

(71) Applicant: Ningde Amperex Technology Limited, Ningde (CN)

(72) Inventors: Guowen ZHANG, Ningde (CN); Mingqi CHEN, Ningde (CN)

(73) Assignee: Ningde Amperex Technology Limited, Ningde (CN)

(21) Appl. No.: 18/933,180

(22) Filed: Oct. 31, 2024

(30) Foreign Application Priority Data
Nov. 1, 2023 (CN) 202322960725.2

(51) Int. Cl. H01M 50/342; H01M 50/103

(52) U.S. Cl. CPC H01M 50/3425; H01M 50/103

(57) ABSTRACT

A battery cell includes a housing and a pressure relief mechanism. A first through-hole is created on the housing. The pressure relief mechanism covers the first through hole. A cover sheet in the pressure relief mechanism is bonded to the housing by the adhesive film. A first passivation layer is disposed on a surface of the cover sheet. The adhesive film is meltable by heat to make the cover sheet fall off to form a pressure relief channel communicating inside and outside of the housing.

### CROSS-REFERENCE TO RELATED APPLICATION

This application claims priority to the Chinese Patent Application Serial No. 202322960725.2, filed on Nov. 1, 2023, the content of which is incorporated herein by reference in its entirety.

### TECHNICAL FIELD

This application relates to the battery field, and in particular, to a battery cell and an electrical device.

### BACKGROUND

A rechargeable battery, also known as a secondary battery, is a battery that is reusable after the active material is activated by charging the battery that is discharged. Rechargeable batteries are widely used in electronic devices such as a mobile phone, a notebook computer, an electric power cart, an electric vehicle, an electric airplane, an electric ship, an electric toy car, an electric toy ship, an electric toy airplane, and a power tool.

Currently, a notch is typically created on the shell cover of a battery cell to release pressure when the gas pressure in the battery cell is excessively high. However, the thermal sensitivity of the notch in this technical solution is relatively low, thereby making the pressure release reliability relatively low. How to improve the pressure release reliability of the battery cell has always been a concern of technicians in this field.

### SUMMARY

This application provides a battery cell and an electrical device. The battery cell can improve the pressure relief reliability of the battery cell.

According to a first aspect, this application provides a battery cell. The battery cell includes a housing and a pressure relief mechanism. A first through-hole is created on the housing. The pressure relief mechanism covers the first through-hole. The pressure relief mechanism includes an adhesive film and a cover sheet. The cover sheet is bonded to the housing by the adhesive film. The adhesive film is meltable by heat to make the cover sheet fall off to form a pressure relief channel communicating inside and outside of the housing. A first passivation layer is disposed on a surface of the cover sheet.

In the above structure, because the first passivation layer is disposed on the surface of the cover sheet, the cover sheet is resistant to corrosion and highly reliable. In addition, the adhesive film melted by heat can make the cover sheet fall off to form a pressure relief channel communicating the inside and outside of the housing, so that the thermal sensitivity of the pressure relief mechanism in the battery cell is high and the pressure relief reliability of the battery cell is high.

In the battery cell according to some embodiments of this application, a thickness of the cover sheet in an axial direction of the first through-hole is H₁, satisfying: 0.08 mm≤H₁≤0.3 mm.

In the battery cell according to some embodiments of this application, the length of the first through-hole in a first direction is greater than the length of the first through-hole in a second direction. The first direction is perpendicular to the second direction. Both the first direction and the second direction are perpendicular to an axial direction of the first through-hole.

In the battery cell according to some embodiments of this application, the pressure relief mechanism further includes an adapter piece connected to the outside of the housing. A second through-hole is created in the adapter piece. The second through-hole communicates to the first through-hole. The cover sheet is bonded to one side of the adapter piece through the adhesive film, the side being away from the housing.

In the battery cell according to some embodiments of this application, along an axial direction of the second through-hole, a projection of the second through-hole lies inside a projection of the first through-hole.

In the battery cell according to some embodiments of this application, a second passivation layer is disposed on a surface of the adapter piece.

In the battery cell according to some embodiments of this application, the first passivation layer includes chromium oxide, and the second passivation layer includes chromium oxide.

In the battery cell according to some embodiments of this application, a thickness of the first passivation layer is H₂, satisfying: 8 nm≤H₂≤180 nm; and a thickness of the second passivation layer is H₃, satisfying: 8 nm≤H₃≤180 nm.

In the battery cell according to some embodiments of this application, the second through-hole is a circular hole. A diameter of the second through-hole is D₁, satisfying: 0.3 mm≤D₁≤2.5 mm.

In the battery cell according to some embodiments of this application, the cover sheet is a circular sheet. A diameter of the cover sheet is D₂, satisfying: D₁<D₂, and 1.5 mm≤D₂≤3.5 mm.

In the battery cell according to some embodiments of this application, the adapter piece is a circular ring. An outer diameter of the adapter piece is D₃, satisfying: 2 mm≤D₃≤5 mm.

In the battery cell according to some embodiments of this application, a thickness of the adapter piece in an axial direction of the second through-hole is H₄, satisfying: 0.03 mm≤H₄≤2 mm.

In the battery cell according to some embodiments of this application, the length of the second through-hole in a first direction is greater than the length of the second through-hole in a second direction. The first direction is perpendicular to the second direction. Both the first direction and the second direction are perpendicular to an axial direction of the first through-hole.

In the battery cell according to some embodiments of this application, the first through-hole is an injection hole.

In the battery cell according to some embodiments of this application, a thickness of the adhesive film is H₅, satisfying: 0.03 mm≤H₅≤2 mm.

In the battery cell according to some embodiments of this application, a melting point of the adhesive film is T, satisfying: 110° C.≤T≤130° C.

According to a second aspect, some embodiments of this application provide an electrical device. The electrical device includes the battery cell disclosed in any one of the above technical solutions. The battery cell is configured to provide electrical energy.

The technical solutions disclosed herein bring at least the following beneficial effects:

This application discloses a battery cell. The battery cell includes a housing and a pressure relief mechanism. A first through-hole is created on the housing. The pressure relief mechanism covers the first through hole. A cover sheet in the pressure relief mechanism is bonded to the housing by the adhesive film. A first passivation layer is disposed on a surface of the cover sheet. The adhesive film is meltable by heat to make the cover sheet fall off to form a pressure relief channel communicating inside and outside of the housing. In the above structure, because the first passivation layer is disposed on the surface of the cover sheet, the cover sheet is resistant to corrosion and highly reliable. In addition, the adhesive film melted by heat can make the cover sheet fall off to form a pressure relief channel communicating the inside and outside of the housing, so that the thermal sensitivity of the pressure relief mechanism in the battery cell is high and the pressure relief reliability of the battery cell is high.

### BRIEF DESCRIPTION OF DRAWINGS

The following describes features, advantages, and technical effects of exemplary embodiments of this application with reference to accompanying drawings.

FIG. 1 is a schematic structural diagram of a battery cell according to an embodiment of this application;

FIG. 2 is a schematic exploded view of a battery cell according to an embodiment of this application;

FIG. 3 is a cross-sectional view of a cover sheet in a battery cell according to an embodiment of this application;

FIG. 4 is a cross-sectional view of sectioning along an A-A line shown in FIG. 1;

FIG. 5 is a close-up view of a part B shown in FIG. 4; and

FIG. 6 is a cross-sectional view of an adapter piece in a battery cell according to an embodiment of this application.

### LIST OF REFERENCE NUMERALS

1. housing; 11. first through-hole; 2. pressure relief mechanism; 21. adhesive film; 22. cover sheet; 23. adapter piece; 231. second passivation layer; 232. second through-hole; X. first direction; Y. second direction; 10. battery cell.

The drawings are not necessarily drawn to scale.

### DETAILED DESCRIPTION

To make the objectives, technical solutions, and advantages of some embodiments of this application clearer, the following gives a clear and complete description of the technical solutions in some embodiments of this application with reference to the drawings in some embodiments of this application. Apparently, the described embodiments are merely a part of but not all of the embodiments of this application.

Currently, the market trend shows that batteries are applied more extensively. Batteries are not only used in energy storage power systems such as hydro, thermal, wind, and solar power stations, but also widely used in electric means of transport such as electric bicycles, electric motorcycles, and electric vehicles, and used in many other fields such as military equipment and aerospace.

The battery cell disclosed in an embodiment of this application may be a secondary battery or a primary battery. The secondary battery is a battery that is reusable in through activation of an active material in the battery cell by charging the battery that is discharged.

The battery cell may be a lithium-ion battery cell, a sodium-ion battery cell, a sodium-lithium-ion battery cell, a lithium metal battery cell, a sodium metal battery cell, a lithium-sulfur battery cell, a magnesium-ion battery cell, a nickel-hydrogen battery cell, a nickel-cadmium battery cell, a lead storage battery cell, or the like.

A battery cell typically includes an electrode assembly. The electrode assembly includes a positive electrode, a negative electrode, and a separator. During charge and discharge of a battery cell, active ions (such as lithium ions) are shuttled between the positive electrode and the negative electrode by intercalation and deintercalation. Disposed between the positive electrode and the negative electrode, the separator piece serves to prevent a short circuit between the positive electrode and the negative electrode and allow passage of the active ions.

In some embodiments, the electrode assembly assumes a jelly-roll structure or a stacked structure. Optionally, the electrode assembly is a cylindrical jelly-roll structure.

In some embodiments, the battery cell may include a shell. The shell is configured to package components such as the electrode assembly and the electrolyte. The shell may be a steel shell, an aluminum shell, a plastic shell (for example, polypropylene), a composite metal shell (for example, a copper-aluminum composite shell), or the like.

As an example, the battery cell may be a cylindrical cell, a prismatic cell, or other-shaped cell. The prismatic cells include a square-shell cell, a blade-shaped cell, and a polygonal prism cell. An example of the polygonal prism cell is hexagonal prism cell, or the like.

The battery cell generates heat when working. Especially, when the battery cell is in a thermal runaway state, a large amount of heat is generated, a large amount of gas is released at the same time, and the pressure inside the battery cell rises sharply. In order to reduce the occurrence of dangers such as explosion, a pressure relief mechanism is usually disposed on the shell cover of the battery cell to release the pressure. In the related art, for commonly seen steel-shell batteries, a notch is usually created on the shell cover. In this way, when the gas pressure inside the battery cell is excessively high, the notch is ruptured to form a pressure relief channel to release the internal pressure. However, the notch in this technical solution is of relatively low thermal sensitivity, and is unable to respond to overheating status in time, thereby making the pressure release reliability relatively low.

In view of the above situation, in order to improve the pressure relief reliability of the battery cell, this application discloses a battery cell. The battery cell includes a housing and a pressure relief mechanism. A first through-hole is created on the housing. The pressure relief mechanism covers the first through hole. The pressure relief mechanism includes an adhesive film and a cover sheet. The cover sheet is bonded to the housing by the adhesive film. A first passivation layer is disposed on a surface of the cover sheet. The adhesive film is meltable by heat to make the cover sheet fall off to form a pressure relief channel communicating inside and outside of the housing. In the above structure, because the first passivation layer is disposed on the surface of the cover sheet, the cover sheet is resistant to corrosion and highly reliable. In addition, the adhesive film melted by heat can make the cover sheet fall off to form a pressure relief channel communicating the inside and outside of the housing, so that the thermal sensitivity of the pressure relief mechanism in the battery cell is high and the pressure relief reliability of the battery cell is high.

The following further describes the technical solutions of a battery cell and an electrical device disclosed herein with reference to specific embodiments.

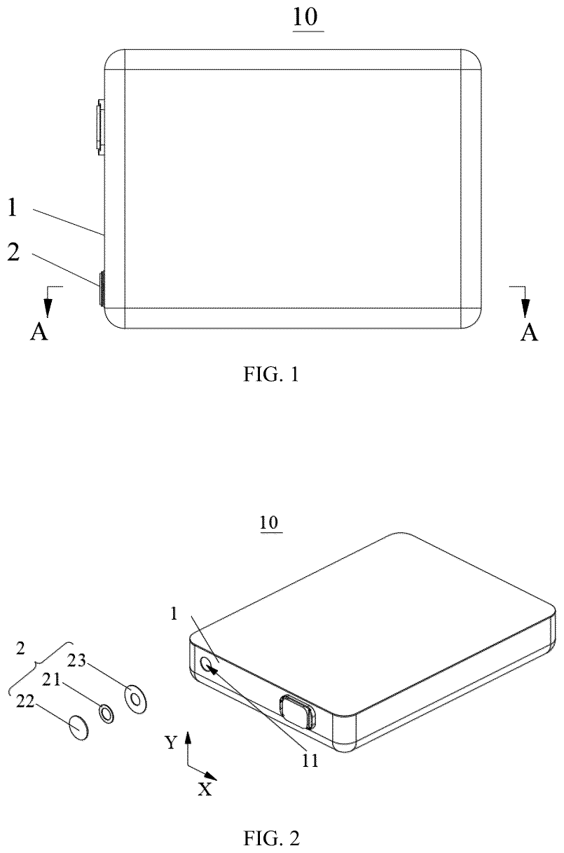

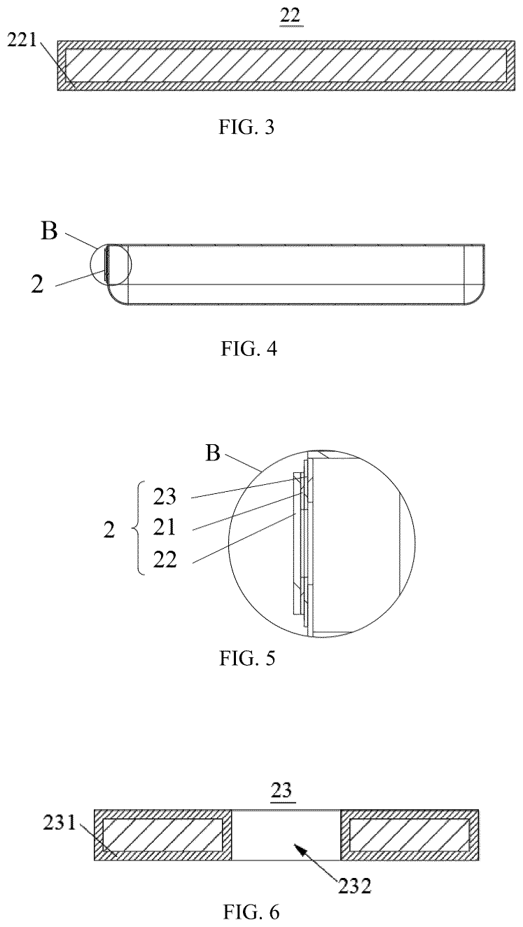

Some embodiments of this application provide a battery cell 10. As shown in FIG. 1, the battery cell 10 includes a housing 1 and a pressure relief mechanism 2. As shown in FIG. 2, a first through-hole 11 is created on the housing 1. The pressure relief mechanism 2 covers the first through-hole 11. The pressure relief mechanism 2 includes an adhesive film 21 and a cover sheet 22. The cover sheet 22 is bonded to the housing 1 by the adhesive film 21. The adhesive film 21 is meltable by heat to make the cover sheet 22 fall off to form a pressure relief channel communicating the inside and the outside of the housing 1. As shown in FIG. 3, a first passivation layer 221 is disposed on a surface of the cover sheet 22.

The housing 1 may be a wall structure disposed on the periphery of the battery cell 10, and can form an accommodation cavity configured to accommodate other components such as an electrode assembly and an electrolyte of the battery cell 10. The housing 1 can protect the components in the accommodation cavity. The first through-hole 11 may be a hole-shaped structure disposed on the housing 1. The first through-hole communicates the inside and the outside of the housing 1.

The pressure relief mechanism 2 may be a component disposed on the housing 1 and configured to release the internal pressure of the battery cell 10. The pressure relief mechanism covers the first through-hole 11. The pressure relief mechanism 2 enables the first through-hole 11 to communicate with the outside so that the pressure inside the battery cell 10 can be released to the outside.

The cover sheet 22 may be a sheet-like component configured to cover the first through-hole 11 in the pressure relief mechanism 2. The cover sheet is configured to block the first through-hole 11 and isolate the battery cell 10 from the outside under normal working conditions. In some embodiments, the cover sheet 22 may be a metal piece of a relatively high thermal conductivity. In this way, the cover sheet 22 is of high thermal conductivity, thereby improving the thermal pressure relief sensitivity of the pressure relief mechanism 2. As an example, the cover sheet 22 may be a nickel sheet. Nickel is of a relatively high thermal conductivity, and can further improve the thermal pressure relief sensitivity of the battery cell 10.

The adhesive film 21 may be a film structure formed by solidifying a hot-melt adhesive substance. The cover sheet 22 is bonded to the housing 1 by the adhesive film 21. The adhesive film 21 formed by the hot-melt adhesive substance is melted when heated so that the bonding force of the adhesive film is decreased. The cover sheet 22 can fall off from the housing 1 under the action of the internal pressure of the battery cell 10. In this way, the first channel communicates the inside and the outside of the housing 1 to form a pressure relief channel. The substances inside the housing 1 are released to the outside through the pressure relief channel.

The first passivation layer 221 may be a structural layer disposed on the surface of the cover sheet 22, and may be formed by passivating the surface material of the cover sheet 22. The first passivation layer 221 is chemically inactive and not easily corroded, so that the cover sheet 22 is highly corrosion-resistant, thereby improving the reliability of the cover sheet 22 in sealing the first through-hole 11.

In the above structure, because the first passivation layer 221 is disposed on the surface of the cover sheet 22, the cover sheet 22 is resistant to corrosion and highly reliable. In addition, the adhesive film 21 melted by heat can make the cover sheet 22 fall off to form a pressure relief channel communicating the inside and outside of the housing 1, so that the thermal sensitivity of the pressure relief mechanism 2 in the battery cell 10 is high and the pressure relief reliability of the battery cell 10 is high.

In some embodiments, the thickness of the cover sheet 22 in an axial direction of the first through-hole 11 is H₁, satisfying: 0.08 mm≤H₁≤0.3 mm.

By setting the thickness H₁ of the cover sheet 22 in the axial direction of the first through-hole 11 to fall within the range of 0.08 mm≤H₁≤0.3 mm, the cover sheet 22 is endowed with sufficient strength, and is prevented from being easily broken under normal working conditions and causing sealing failure, and is prevented from being excessively thick to cause a waste of material.

In some embodiments, 0.1 mm≤H₁≤0.2 mm. The cover sheet 22 falling within this thickness range not only seals the first through-hole 11 well, but also saves material, thereby reducing the cost of the battery cell 10. As an example, the thickness H₁ of the cover sheet 22 in the axial direction of the first through-hole 11 may be 0.13 mm, 0.15 mm, or 0.17 mm. The cover sheet 22 can seal the first through-hole 11 well while saving material.

In some embodiments, the length of the first through-hole 11 in the first direction X is greater than the length of the first through-hole 11 in the second direction Y. The first direction X is perpendicular to the second direction Y. Both the first direction X and the second direction Y are perpendicular to the axial direction of the first through-hole 11.

The first direction X may be a direction parallel to the housing 1 part at which the first through-hole 11 is created, and is perpendicular to the axial direction of the first through-hole 11. The second direction Y may be a direction parallel to the housing 1 part at which the first through-hole 11 is created, and is perpendicular to the axial direction of the second through-hole 232. The first direction X and the second direction Y are perpendicular to each other. The first direction X may be a length direction of the housing 1 part, and the second direction Y may be a width direction of the housing 1 part. By making the length of the first through-hole 11 in the first direction X greater than the length of the first through-hole 11 in the second direction Y, this application achieves a larger cross-sectional area of the first through-hole 11, and facilitates the cover sheet 22 to quickly fall off under the action of the internal pressure of the battery cell 10 in the case of thermal runaway.

In some embodiments, as shown in FIG. 2, the pressure relief mechanism 2 further includes an adapter piece 23 connected to the outside of the housing 1. A second through-hole 232 is created in the adapter piece 23. The second through-hole 232 communicates to the first through-hole 11. As shown in FIG. 4 and FIG. 5, the cover sheet 22 is bonded to one side of the adapter piece 23 through the adhesive film 21, the side being away from the housing 1.

The adapter piece 23 may be a component configured to connect the cover sheet 22 on the housing 1. With the adapter piece 23 disposed on the outer side of the housing 1, the cover sheet 22 can be conveniently and firmly connected to the housing 1 by the adapter piece 23.

In some embodiments, the adapter piece 23 may be a sheet-like component. The two sides of the adapter piece in the thickness direction are connected to the housing 1 and the cover sheet 22 respectively. In this way, the adapter piece 23 provides a relatively large lateral face for being connected to the housing 1 and the cover sheet 22, thereby improving the firmness of connection of the adapter piece 23 to the housing 1 and the cover sheet 22. As an example, the adapter piece 23 may be made of a nickel sheet. Nickel is of a relatively high thermal conductivity, thereby further improving the thermal pressure relief sensitivity of the battery cell 10. Alternatively, the adapter piece 23 may be made of nickel-plated stainless steel, thereby reducing the cost of the adapter piece 23 while making the adapter piece 23 be of high thermal conductivity.

As an example, the adapter piece 23 may be bonded to the outer side of the housing 1 by adhesive, so as to facilitate connection between the adapter piece 23 and the housing 1. Alternatively, the adapter piece 23 may be welded to the outer side of the housing 1 by welding, so that the materials of the adapter piece 23 and the housing 1 can be melted into one, thereby achieving a firm connection between the adapter piece 23 and the housing 1.

In some embodiments, the adapter piece 23 may be connected to the outer side of the housing 1 by laser welding. In this way, the quality of welding between the adapter piece 23 and the housing 1 is relatively high, thereby improving the firmness of the connection between the adapter piece 23 and the housing 1. As an example, the adapter piece 23 may be connected to the housing 1 by laser penetration welding. The laser penetration welding not only implements the welding of a metal material quickly and efficiently, improves the efficiency of the manufacturing process, but also achieves superior quality of the weld at the junction of the metal material, thereby being not prone to cause corrosion, discoloration, and other problems on the surface of the adapter piece 23, and further improving the firmness and reliability of the connection between the adapter piece 23 and the housing 1.

The second through-hole 232 may be a hole-shaped structure created on the adapter piece 23. The second through-hole communicates to the first through-hole 11, and penetrates the adapter piece 23 along the thickness direction of the adapter piece 23. In this way, the emissions can enter the second through-hole 232 from the first through-hole 11, and be conveniently expelled out of the battery cell 10. In some embodiments, the axis of the second through-hole 232 is configured to be the same as the axis of the first through-hole 11, so that the second through-hole 232 and the first through-hole 11 are coaxial, thereby not only facilitating the discharge of the emissions, but also making it convenient to dispose the adapter piece 23 at the position of the first through-hole 11.

The cover sheet 22 is bonded to the adapter piece 23 by the adhesive film 21 and covers the second through-hole 232. In this way, when the cover sheet 22 or the adapter piece 23 is heated, the adhesive film 21 can melt, and the cover sheet 22 can fall off from the adapter piece 23, thereby releasing the pressure of the battery cell 10.

In some embodiments, along the axial direction of the second through-hole 232, the projection of the second through-hole 232 lies inside the projection of the first through-hole 11.

By controlling the projection of the second through-hole 232 in the axial direction of the second through-hole 232 to lie inside the projection of the first through-hole 11, the cross-sectional area of the first through-hole 11 is made larger than the cross-sectional area of the second through-hole 232. In this way, the emissions inside the housing 1 can flow smoothly along the arrangement direction of the second through-hole 232 and the first through-hole 11. In addition, controlling the cross-sectional area of the second through-hole 232 to be smaller than the cross-sectional area of the first through-hole 11, the cover sheet 22 can contact the adapter piece 23 in a relatively large contact area, thereby improving the reliability of connection between the cover sheet 22 and the adapter piece 23.

In some embodiments, as shown in FIG. 6, a second passivation layer 231 is disposed on the surface of the adapter piece 23.

The second passivation layer 231 may be a structural layer disposed on the surface of the adapter piece 23, and may be formed by passivating the surface material of the adapter piece 23. The second passivation layer 231 is chemically inactive and not easily corroded, so that the adapter piece 23 is highly corrosion-resistant, thereby improving the reliability of the adapter piece 23.

In some embodiments, the first passivation layer 221 includes chromium oxide, and the second passivation layer 231 includes chromium oxide.

Chromium oxide is stable in nature and insoluble in water, acid, and alkaline solutions. By making the first passivation layer 221 include chromium oxide, the first passivation layer 221 is made stable in nature and highly corrosion-resistant, thereby effectively alleviating the adverse effect caused by the electrolyte solution corroding the cover sheet 22, and improving the sealing reliability of the cover sheet 22. By making the second passivation layer 231 include chromium oxide, the second passivation layer 231 is made stable in nature and highly corrosion-resistant, thereby effectively alleviating the adverse effect caused by the electrolyte solution corroding the adapter piece 23, and improving the sealing reliability of the adapter piece 23.

In some embodiments, the first passivation layer 221 may be formed by immersing the cover sheet 22 in a chromate solution. As an example, before the cover sheet 22 is immersed in the chromate solution, the cover sheet 22 needs to be cleaned to improve the quality of the formed first passivation layer 221. Similarly, the second passivation layer 231 may be formed by immersing the adapter piece 23 in a chromate solution. As an example, before the adapter piece 23 is immersed in the chromate solution, the adapter piece 23 needs to be cleaned to improve the quality of the formed second passivation layer 231.

In some embodiments, the thickness of the first passivation layer 221 is H₂, satisfying: 8 nm≤H₂≤180 nm; and the thickness of the second passivation layer 231 is H₃, satisfying: 8 nm≤H₃≤180 nm.

By setting the thickness H₂ of the first passivation layer 221 to fall within the range of 8 nm≤H₂≤180 nm, the cover sheet 22 is corrosion-resistant enough and is not easily damaged by corrosion by the substances such as electrolyte solution, and avoids a high cost caused by the large thickness of the first passivation layer 221.

In some embodiments, 10 nm≤H₂≤150 nm. The first passivation layer 221 falling within this thickness range not only makes the cover sheet 22 highly resistant to corrosion, but also saves material, thereby reducing the cost of the battery cell 10. As an example, the thickness H₂ of the first passivation layer 221 may be 50 nm, 80 nm, or 120 nm. The first passivation layer 221 can make the cover sheet 22 highly resistant to corrosion and save material.

By setting the thickness H₃ of the second passivation layer 231 to fall within the range of 8 nm≤H₃≤180 nm, the adapter piece 23 is corrosion-resistant enough and is not easily damaged by corrosion by the substances such as electrolyte solution, and avoids a high cost caused by the large thickness of the second passivation layer 231.

In some embodiments, 10 nm≤H₃≤150 nm. The second passivation layer 231 falling within this thickness range not only makes the adapter piece 23 highly resistant to corrosion, but also saves material, thereby reducing the cost of the battery cell 10. As an example, the thickness H₃ of the second passivation layer 231 may be 50 nm, 80 nm, or 120 nm. The second passivation layer 231 can make the adapter piece 23 highly resistant to corrosion and save material.

In some embodiments, the second through-hole 232 is a circular hole. The diameter of the second through-hole 232 is D₁, satisfying: 0.3 mm≤D₁≤2.5 mm.

By making the second through-hole 232 be a circular hole, the stress borne by the adapter piece 23 is reduced, the probability of deformation of the adapter piece 23 is reduced, and additionally, the processing difficulty of the second through-hole 232 is lower. By setting the diameter D₁ of the second through-hole 232 to fall within the range of 0.3 mm≤D₁≤2.5 mm, the second through-hole 232 provides a sufficient cross-sectional area for releasing emissions, and the pressure relief mechanism 2 provides a sufficient pressure relief capacity, and additionally, the sealing effect is not easily impaired by the large size of the second through-hole 232.

In some embodiments, 0.5 mm≤D₁≤2 mm. This diameter range not only meets the requirement of releasing the emissions, but also enables the adapter piece 23 to maintain a strong structural strength. As an example, the diameter D₁ of the second through-hole 232 may be 1 mm, 1.5 mm, or 1.8 mm, so that the adapter piece 23 is highly capable of releasing emissions while being strong enough.

In some embodiments, the cover sheet 22 is a circular sheet. The diameter of the cover sheet 22 is D₂, satisfying: D₁<D₂, and 1.5 mm≤D₂≤3.5 mm.

By making the cover sheet 22 be a circular sheet, the shape of the cover sheet 22 matches that of the second through-hole 232, thereby facilitating the cover sheet 22 to cover and seal the second through-hole 232. By making the diameter D₂ of the cover sheet 22 satisfy D₁<D₂, the cover sheet 22 can be well connected to the adapter piece 23 when covering the second through-hole 232, so as to seal the second through-hole 232 firmly.

As an example, by setting the diameter D₂ of the cover sheet 22 to fall within the range of 1.5 mm≤D₂≤3.5 mm, the cover sheet 22 not only provides a sufficient area for being well connected to the adapter piece 23, but also avoids waste caused by a large area.

In some embodiments, 2 mm≤D₂≤3 mm. This diameter range not only meets the requirement of the cover sheet 22 for sealing the second through-hole 232, but also avoids waste. As an example, the diameter D₂ of the cover sheet 22 may be 2.3 mm, 2.5 mm, or 2.8 mm, so that the cover sheet 22 is well connected to the adapter piece 23, without being prone to cause waste.

In some embodiments, the adapter piece 23 is a circular ring. The outer diameter of the adapter piece 23 is D₃, satisfying: 2 mm≤D₃≤5 mm.

The adapter piece 23 is a circular ring, and the second through-hole 232 is a hole in the circular ring. By setting the outer diameter D₃ of the adapter piece 23 to fall within the range of 2 mm≤D₃≤5 mm, the cover sheet 22 not only provides a sufficient area for being well connected to the housing 1, but also avoids waste caused by a large area.

In some embodiments, 3 mm≤D₃≤4 mm. This diameter range not only meets the requirement of connection between the adapter piece 23 and the housing 1, but also avoids waste. As an example, the diameter D₃ of the cover sheet 22 may be 3.2 mm, 3.5 mm, or 3.8 mm, so that the adapter piece 23 is well connected to the housing 1, without being prone to cause waste.

In some embodiments, the thickness of the adapter piece 23 in the axial direction of the second through-hole 232 is H₄, satisfying: 0.03 mm≤H₄≤2 mm.

By setting the thickness H₄ of the adapter piece 23 in the axial direction of the second through-hole 232 to fall within the range of 0.03 mm≤H₄≤2 mm, the adapter piece 23 is endowed with sufficient strength, and is prevented from being easily damaged under normal working conditions and causing sealing failure, and is prevented from being excessively thick to cause a waste of material.

In some embodiments, 0.05 mm≤H₄≤1.5 mm. The adapter piece 23 falling within this thickness range is not only strong enough, but also saves material, thereby reducing the cost of the battery cell 10. As an example, the thickness H₄ of the adapter piece 23 in the axial direction of the second through-hole 232 may be 0.08 mm, 1 mm, or 1.3 mm, so that the adapter piece 23 is strong enough and saves material.

In some embodiments, the length of the second through-hole 232 in the first direction X is greater than the length of the second through-hole 232 in the second direction Y. The first direction X is perpendicular to the second direction Y. Both the first direction X and the second direction Y are perpendicular to the axial direction of the first through-hole 11.

The first direction X and the second direction Y are perpendicular to each other, and both directions are perpendicular to the axial direction of the first through-hole 11, so that the first direction X and the second direction Y are two mutually perpendicular directions on the same plane. By setting the length of the second through-hole 232 in the first direction X to be greater than the length of the second through-hole 232 in the second direction Y, the second through-hole 232 can have a larger cross-sectional area in the second direction Y, thereby improving the capacity of the second through-hole 232 in releasing emissions.

In some embodiments, the cross-sectional shape of the second through-hole 232 may be a rectangle, a rhombus, or an ellipse. In this way, the length of the second through-hole 232 in the second direction Y is greater than the length in the first direction X, so that the cross-sectional area of the second through-hole 232 is relatively large. As an example, the first direction X may be the length direction of the housing 1, and the second direction Y may be the thickness direction of the housing 1. A person skilled in the art may set the specific directions of the first direction X and the second direction Y according to actual conditions.

In some embodiments, the first through-hole 11 is an injection hole.

Reuse of the injection hole as the first through-hole 11 for pressure relief can further simplify the manufacturing process of the battery cell 10, save the step of hole punching, and reduce the manufacturing cost of the battery cell 10.

In some other embodiments, the first through-hole 11 may be another through-hole formed on the housing 1 and communicating to the inside and outside of the housing 1.

In some embodiments, the thickness of the adhesive film 21 is H₅, satisfying: 0.03 mm≤H₅≤2 mm.

The adhesive film 21 overflows in a molten state. An excessively large overflow impairs the pressure relief efficiency of the pressure relief mechanism 2. Therefore, by setting the thickness H₅ of the adhesive film 21 to fall within the range of 0.03 mm≤H₅≤2 mm, the adhesive film 21 is endowed with sufficient bonding strength to well bond the cover sheet 22 to the housing 1 or the adapter piece 23, and additionally, the pressure relief efficiency of the pressure relief mechanism 2 is not impaired by the excessive overflow.

In some embodiments, 0.05 mm≤H₅≤1.5 mm. This thickness range of the adhesive film 21 not only meets the requirement of connection of the cover sheet 22 to the housing 1 or the adapter piece 23, but also avoids waste. As an example, the thickness H₅ of the adhesive film 21 may be 0.08 mm, 1 mm, or 1.2 mm, so that the cover sheet 22 is well connected to the housing 1 or the adapter piece 23, without being prone to cause waste.

As an example, the shape of the adhesive film 21 bonded between the cover sheet 22 and the housing 1 or the adapter piece 23 may be in the shape of a circular ring, so that the adhesive film 21 can match the shape of the cover sheet 22 and the second through-hole 232.

In some embodiments, the melting point of the adhesive film 21 is T, satisfying: 110° C.≤T≤130° C.

By setting the melting point T of the adhesive film 21 to fall within the range of 110° C.≤T≤130° C., the adhesive film 21 is endowed with high thermal sensitivity in a case of thermal runaway and is prevented from melting under normal working conditions.

In some embodiments, 118° C.≤T≤128° C. This melting point range of the adhesive film 21 not only endows the pressure relief mechanism 2 with a high thermal sensitivity, but also reduces the probability of melting under normal working conditions.

As an example, the melting point T of the adhesive film 21 may be 120° C. or 125° C., so that the adhesive film 21 is superior in both thermal sensitivity and reliability.

In some embodiments, the adhesive film 21 may be made of polypropylene, so that the adhesive film 21 achieves high bonding strength and the adhesive film 21 can firmly bond the cover sheet 22 to the housing 1 or the adapter piece 23. As an example, the adhesive film 21 may be made of at least one of thermoplastic materials such as polyethylene, polyvinyl chloride, polystyrene, polyamide, polyoxymethylene, polycarbonate, polyphenylene oxide, polysulfone, or rubber. In this way, the adhesive film 21 can be melted by heat to make the cover sheet 22 fall off from the housing 1 or the adapter piece 23.

Some embodiments of this application further provide an electrical device. The electrical device includes the battery cell 10 disclosed in the above technical solution. The battery cell 10 is configured to provide electrical energy. The electrical device includes the battery cell 10 disclosed in the above technical solution, and therefore, the battery in the electrical device is not prone to thermal runaway and is highly reliable.

Although this application has been described with reference to exemplary embodiments, various improvements may be made to the embodiments without departing from the scope of this application, and the components of this application may be replaced with equivalents. Particularly, to the extent that no structural conflict exists, various technical features mentioned in various embodiments may be combined in any manner. This application is not limited to the specific embodiments disclosed herein, but includes all technical solutions falling within the scope of the claims.

What is claimed is:

1. A battery cell, comprising:
a housing, wherein a first through-hole is provided on the housing; and
a pressure relief mechanism covering the first through-hole, wherein the pressure relief mechanism comprises an adhesive film and a cover sheet, the cover sheet is bonded to the housing by the adhesive film, the adhesive film is meltable by heat to make the cover sheet fall off to form a pressure relief channel communicating inside and outside of the housing, and a first passivation layer is disposed on a surface of the cover sheet.

2. The battery cell according to claim 1, wherein a thickness of the cover sheet in an axial direction of the first through-hole is H₁, and 0.08 mm≤H₁≤0.3 mm.

3. The battery cell according to claim 1, wherein a length of the first through-hole in a first direction is greater than a length of the first through-hole in a second direction, the first direction is perpendicular to the second direction, and both the first direction and the second direction are perpendicular to an axial direction of the first through-hole.

4. The battery cell according to claim 1, wherein the pressure relief mechanism further comprises an adapter piece connected to an outside surface of the housing, a second through-hole is created in the adapter piece, the second through-hole communicates with the first through-hole, and the cover sheet is bonded to one side of the adapter piece through the adhesive film, the one side of the adapter piece being facing away from the housing.

5. The battery cell according to claim 4, wherein, along an axial direction of the second through-hole, a projection of the second through-hole lies inside a projection of the first through-hole.

6. The battery cell according to claim 4, wherein a second passivation layer is disposed on a surface of the adapter piece.

7. The battery cell according to claim 6, wherein the first passivation layer comprises chromium oxide, and the second passivation layer comprises chromium oxide.

8. The battery cell according to claim 6, wherein a thickness of the first passivation layer is H₂, and 8 nm≤H₂≤180 nm; and a thickness of the second passivation layer is H₃, and 8 nm≤H₃≤180 nm.

9. The battery cell according to claim 8, wherein 10 nm≤H₂≤150 nm; and 10 nm≤H₃≤150 nm.

10. The battery cell according to claim 4, wherein the second through-hole is a circular hole, and a diameter of the second through-hole is D₁, and 0.3 mm≤D₁≤2.5 mm.

11. The battery cell according to claim 10, wherein 0.5 mm≤D₁≤2 mm.

12. The battery cell according to claim 11, wherein the cover sheet is a circular sheet, and a diameter of the cover sheet is D₂, D₁<D₂, and 1.5 mm≤D₂≤3.5 mm.

13. The battery cell according to claim 12, wherein 2 mm≤D₂≤3 mm.

14. The battery cell according to claim 4, wherein the adapter piece is a circular ring, and an outer diameter of the adapter piece is D₃, and 2 mm≤D₃≤5 mm.

15. The battery cell according to claim 4, wherein a thickness of the adapter piece in an axial direction of the second through-hole is H₄, and 0.03 mm≤H₄≤2 mm.

16. The battery cell according to claim 4, wherein a length of the second through-hole in a first direction is greater than a length of the second through-hole in a second direction, the first direction is perpendicular to the second direction, and both the first direction and the second direction are perpendicular to an axial direction of the first through-hole.

17. The battery cell according to claim 1, wherein the first through-hole is an injection hole.

18. The battery cell according to claim 1, wherein a thickness of the adhesive film is H₅, and 0.03 mm≤H₅≤2 mm.

19. The battery cell according to claim 1, wherein a melting point of the adhesive film is T, and 110° C.≤T≤130° C.

20. An electrical device, wherein the electrical device comprises the battery cell according to claim 1, and the battery cell is configured to provide electrical energy.
